(19) United States
(12) Patent Application Publication
(10) Pub. No.: US 2013/0097563 A1
(43) Pub. Date: Apr. 18, 2013

(54) MULTIDIMENSIONAL-DATA-ORGANIZATION METHOD

(71) Applicants: Luiz Carlos Pacheco Rodrigues Velho, Rio de Janeiro (BR); Andre De Almeida Maximo, Rio de Janeiro (BR); Maria Paula Saba Dos Reis, Rio de Janeiro (BR)

(72) Inventors: Luiz Carlos Pacheco Rodrigues Velho, Rio de Janeiro (BR); Andre De Almeida Maximo, Rio de Janeiro (BR); Maria Paula Saba Dos Reis, Rio de Janeiro (BR)

(73) Assignee: ASSOCIACAO INSTITUTO NACIONAL DE MATEMATICA PURA E APLICADA, Rio de Janeiro (BR)

(21) Appl. No.: 13/805,641

(22) PCT Filed: Jun. 15, 2011
(86) PCT No.: PCT/BR2011/000180

§ 371 Date: Dec. 19, 2012

(30) Foreign Application Priority Data
Jun. 24, 2010 (BR) PI 1004312-8

(51) Int. Cl. G06F 3/0481

(52) U.S. Cl. CPC G06F 3/04815
USPC 715/850

(57) ABSTRACT

The present invention relates to a multiple-dimension-data-organization method. More specifically, this method uses an n-dimensional cube (M-cube) in which each face displays the data on a 2-D planar surface and in which the x and y axes may be changed in accordance with the user's request. More specifically still, the data to be viewed may be easily changed by the user by means of a simple rotation command using a touch-sensitive interface.

### FIELD OF THE INVENTION

The present invention relates to a multiple-dimension-data-organization method. More specifically, this method uses an n-dimensional cube (M-cube) in which each face displays the data on a 2-D planar surface and in which the x and y axes may be changed in accordance with the user's request. More specifically, the axes to be viewed may be easily changed by the user by means of a simple rotation command using a touch-sensitive interface.

### BACKGROUND OF THE INVENTION

The 90's were marked by rapid growth in the size and dimensions of databases required to support the amount of information which grew exponentially with the advent of the Internet. Such growth was noted not only in the field of enterprise data storage, but mainly in the storage of personal data

This impressive growth appears both in the size of databases and in the number of attributes for the classification of raw data.

The attributes of the data (or metadata) have as a function decomposing the set of corresponding data into dimensions, thereby playing an important role: enabling both the consultation and visualization of results for large data sets. However, the complexity behind these tasks is in the human-machine interface (HMI), where metadata should be consistently and significantly used.

In general, data visualization activity helps creating consultations that, in turn, work to produce the best visual effects. This recurring process of consultation and visualization of results aims to extract meaningful information from a data set.

In the state of the art, the most common techniques for consultation and visualization of results employ relational tables and textual languages in order to operate these interactions, i.e., in order to create a consultation and visualize the results arising from each consultation. The result is a poor visualization, with difficult interactivity, as shown in FIG. 1.

One of the features that makes the visualization of large databases especially challenging is its inherent high dimensionality. The n-dimensions may be used to benefit their visualization by means of data classification. This classification is done by projecting elements representing data in each dimension, which leads to an n-dimensional graphic, wherein n is the number of attributes or dimensions of the database. For example, a simple database with three attributes can be described in a 3D graphic. Sometimes the graphic provides a better visualization of the data than those presented in a table, depending on the process of data exploration and visualization.

The data type is an important aspect to be analyzed when building a data visualization tool. However, most of the interfaces available in the state of the art ignore the data to be worked, which generates an inadequate visualization of the results. Examples of such interfaces include: table of numbers (see FIG. 1), discretized or aggregated; graphics with bars, such as histograms; graphics with dispersions with icons or symbols (glyphs), varying in color, size, etc.; data cubes, and so on. A frequent problem arises when working with complex types of data, for example, media data which are poorly visualized with generic tools.

A very used tool for the visualization of multidimensional data is a dynamic table with numbers in cells, called Pivot Table. These tables can be arranged in the form of data cubes, as shown in FIG. 2, wherein each dimension of the relational database may be turned or may have its pivot modified. Since the pivots are arranged in rows and columns of the table, dimensions are aggregated and the results are shown as numbers or represented as graphics.

The use of tables to visualize multidimensional data is due to the fact that they present advantages over the graphics, since they are free to apply a convenient order for the data, whereas in the graphics, data are represented in a fixed sequence, depending on the dimension. However, the problem of using tables is that the interaction is based on a limited visualization of the data set—relational tables—designed to be generic enough to handle with any data type. This limitation makes it difficult to change the pivots, thereby jeopardizing both the visualization and interaction.

In the state of the art there are several technologies that use of graphics and tables that, when involving many multidimensional data, become difficult to be operated and visualized. There can be cited, by way of example, the following:
Apple's™ iTunes™—an important trend for the trade. This technology implements an interaction, based on tables, to deal with a multidimensional database of music. Although it is a personal database, both the interaction and visualization are jeopardized by a difficult interface, where the user should fill attributes in non-intuitive windows. Said technology tries to circumvent this problem by providing an artificial intelligence tool to manage the database for the user, acting in a direction completely opposite from that of an efficient HMI;
the multidimensional Data Viewer. This technology maps visual objects in 3D space according to a certain point of view. Users can interact with the visualization by means of rotation, by changing the point of view and, consequently, the final image. Data elements are displayed as symbols, which have different visual characteristics (such as size and color), creating representation layers upon data types. These layers make the real meaning of the data difficult to distinguish. Another problem arises when trying to choose a good view, that is, the user can get unwanted data multiple times in the final image;
operating systems like Microsoft Windows™ and Apple OSX™. These systems display multimedia content in file browsers, Windows Explorer and the Finder, organizing data in tables and using them in different applications for visualization and interaction with multimedia content; and
Polaris system—This technology provides an interface for exploring large multidimensional databases, which is based on the construction of graphics devices based on tables, allowing consecutive visits. Polaris also explores traditional 2D graphics adding to them an algebraic formalism based on the graphical properties described by Bertin. In this system users can choose among visual basic principles for data visualization, but the visualization is limited by two-dimensional tables and graphics.

In the patent literature there were found some documents that relate to the subject matter described herein without, however, anticipating or suggesting the scope thereof. Just as an example, we mention the following documents: the North American patent U.S. Pat. No. 5,303,388, held by Apple Computer, Inc., entitled “Method to display and rotate a three-dimensional icon with multiple faces”; the North American patent U.S. Pat. No. 5,515,486, also held by Apple Computer, Inc., entitled “Method, apparatus and memory for directing a computer system to display a multi-axis rotatable, polyhedral-shape panel container having front panels for displaying objects”; the North American patent U.S. Pat. No. 5,072,412, held by Xerox Corporation, entitled “User interface with multiple workspaces for sharing display system objects”; the North American patent U.S. Pat. No. 5,233,687, held by Xerox Corporation, entitled “User interface with multiple workspaces for sharing display system objects”; the North American patent application US 20040109031 A1, entitled “Method and system for automatically creating and displaying a customizable three-dimensional graphical user interface (3D GUI) for a computer system”; and the Brazilian patent application PI 0012827-9 A2, held by Computer Associates Think Inc, entitled “Modelo e método de armazenamento multidimensional” (Model and method of multidimensional storage).

Although some technologies related to methods for organizing multidimensional data are known, the present inventors are unaware of a method that uses an n-dimensional cube (M-Cube) in which each face presents data on a 2D plane which can be easily visualized and altered by the user.

### SUMMARY OF THE INVENTION

It is an object of the present invention to provide a method which consists in the organization of a multidimensional data by means of a Multidimensional Cube.

In one aspect of the present invention, the Multidimensional Cube presents, in each face, the data in a 2D plane. Additionally, the x and y axes of the Multidimensional Cube can be altered according to the user request.

Further, in another aspect of the invention, the Multidimensional Cube data can be easily visualized and altered by the user by means of a simple rotation control by using a touch-sensitive interface.

In another aspect of the invention, there are described the possible interactions which occur in the Multidimensional Cube, which are: rotation, filtering, selection and expansion.

These and other objects of the invention will be better appreciated and understood from the detailed description of the invention.

### DESCRIPTION OF DRAWINGS

FIG. 1—Example of a textual consultation language (top left corner) and a table with items related to office and different types of customers.

FIG. 2—Example of the visualization of data from a cube.

FIG. 3—Example of the design of the M-Cube, in which, in addition to the attributes in the three axes, two more attributes are represented by visual properties (color and size) with the legend at the top right corner of the interface.

FIG. 4—Example of representations in the M-Cube for the four media types: music, text, image and video (from the top down and from left to right).

FIG. 5—Shows the act of opening a multimedia data element in a video database.

FIG. 6—Shows the act of choosing among the different scales of a certain attribute, such as, for example, data creation date.

FIG. 7—Shows that the act of rotating changes the visualization of the M-Cube, allowing the exploration of the database.

FIG. 8—Shows that the act of choosing attribute values on the axes reduces the visualization of the M-Cube.

FIG. 9—Shows that the act of filtering uses multiple selections to a new M-Cube from a part of the database; the original M-Cube is displayed in the top right corner.

FIG. 10—Shows the action of the zoom which allows the user to distinguish the data elements in a dense agglomerate of symbols.

FIG. 11—M-Cube prototype for data sets of music, tracks visualization (left) and albums (right).

FIG. 12—Animation of the rotation of M-Cube prototype.

FIG. 13—Use of the M-Cube as a file explorer.

### DETAILED DESCRIPTION OF THE INVENTION

The present invention provides alternatives to overcome the limitations of the state of the art for the development of a multidimensional-data-organization method.

The Multidimensional Cube or M-Cube

The present invention presents a Multidimensional Cube, called M-Cube (or M³), a tool for visualizing multimedia and multidimensional databases.

The fundamental principle of the M-Cube is the interaction with the space, rather than directly with the elements wherein the data are presented. This interaction occurs both by means of the rotation to change the current visualization of the current cube axes, such as by altering visualization scale of data or of the attributes in the axes.

The M-Cube extends the representation of the data cube, by offering a three-dimensional space to visualize and explore multimedia data. In addition to the normal actions, such as the opening of media data, the M-Cube avows two new interactions, i.e. rotation and filtering iterations beyond normal traditional interfaces, which are: selection and amplification.
Rotation—the cube can be rotated for better data visualization or for altering the current dimensions, similar to changing the pivots on dynamic tables;
Filtering—parts of the edges of the cube can be chosen for filtering the current results, producing a new visualization and altering consultations in the exploration recursive process;
Selection—graphic elements inside the cube can be selected individually or together to interact with the data, allowing for example: opening a text file, playing a music or video, selecting multiple files to make a folder or album, etc.
Expansion (or Zoom)—regions inside the cube can be expanded to an adequate view of data, allowing for a quick change of a generic analysis to a more specific one;

Visualization and human-machine interface (HMI) of the M-Cube are simple and intuitive. The user employs natural actions to interact with M-Cube interface and have a graphically rich and meaningful response from the viewing. This helps the whole process of interaction and exploration. Thus, the M-Cube can be used to analyze a full multidimensional database, including multimedia data, and also getting information by searching for a specific content.

3D Visualization Tool

The M-Cube of the present invention is a tool for visualization of multidimensional databases, which employs a 3D space, which is more natural and visually richer than a 2D table, of which data are described by the edges of a cube.

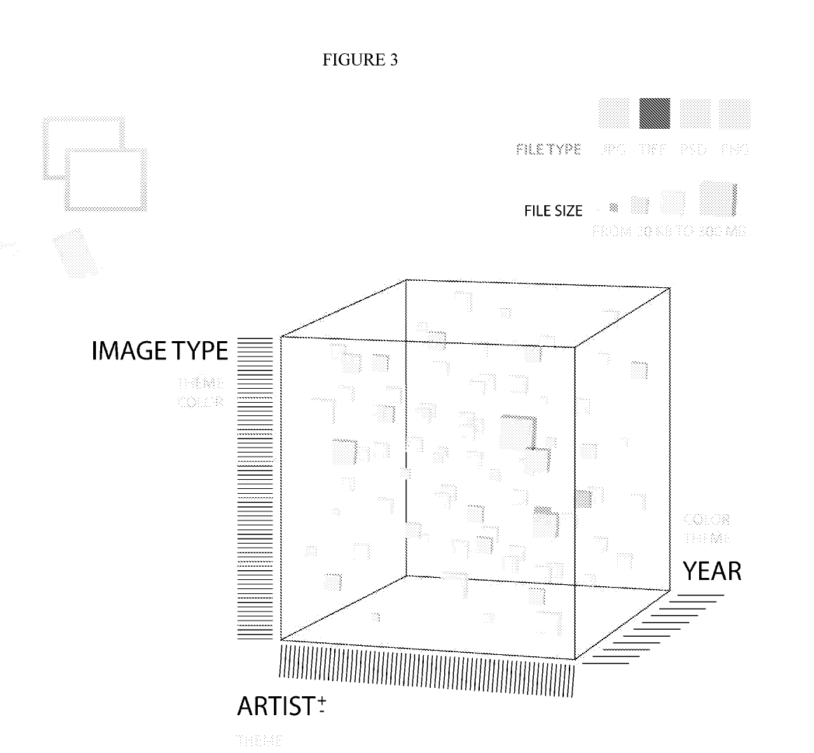

In the M-Cube the elements are designed for the 3D space, as usually done in a three-dimensional dispersion graphic. The result is a projection of the 3D floating object inside the cube. The tool allows a natural rotation of the space, like a real cube, in order to better visualize the data objects. The M-cube also allows that, in the same rotation interface, a change of the three current dimensions which are used to design data occurs. In this case, the user chooses a secondary dimension, i.e., an attribute that is not in use preferential axis, rotates the cube therewith and the axis and it becomes the chosen dimension, instantly changing the visualization. Thus, for example, the user can choose as an attribute the “subject” on the axis “year”, as shown in FIG. 3, rotate the cube from right to left and then change the current visualization to for “local artist and subject.”

In the M-Cube data are displayed as 3D graphic elements, that is, objects with different shapes and colors, representing the meaning of each data type. In FIG. 3, for example, image elements are shown, as boxes with different colors, wherein each color indicates a type of image file.

The visual aspects of the graphic elements are intended to add more dimensions to the original three-dimensional M-cube. For example, both type and size of the image file are encrypted for colored symbols and boxes of different sizes, as shown in FIG. 3, adding, therefore, two new attributes for visualization. In the above example, the M-Cube has five dimensions: “location, artist and year” in the three axes; and “type and size” of the image represented by the graphic elements. These additional attributes are merely illustrative and are not excluded as secondary dimensions, if the user wishes to view them in the M-Cube axes.

The Ways of Interaction

In the M-Cube, the action of choice can be made by clicking with the mouse or by using a touch interface. This last option is the best, since it makes the gesture related to the change of the pivots or of the dimensions more natural and intuitive; the user chooses a secondary dimension through touch and rotates the cube while playing. Another interaction option is of playing in any region inside the cube (excluding axes and edges) by turning said cube without altering the dimensions, but modifying the point of view in which the M-Cube is shown.

In the M-Cube, besides the visualization of the rotation and the change of dimensions, which occurs by means of the touch, there are two other gestures of interactivity that are: expanding and filtering.

For these two acts, it is important to have a multi-touch interface, wherein the touchable screen can recognize more than one touch. In the case of expansion, the user touches with two fingers to determine a region on the screen and (a) by separating the fingers, the visualization region is moved away, whereas (b) by joining the fingers, the region is approximated, thus achieving the expansion of the visualization.

But filtering is done by means of the touch with one or two fingers on a certain axis, determining a specific value of an attribute or an interval of values between the fingers, which is used to make consultations by filtering the database.

The Ways of Visualization for the Different Media Types

The M-Cube is designed for any type of databases, particularly multimedia, providing visualization and interaction in an innovative way.

There are four types of existing media, such as text, music, image and video.

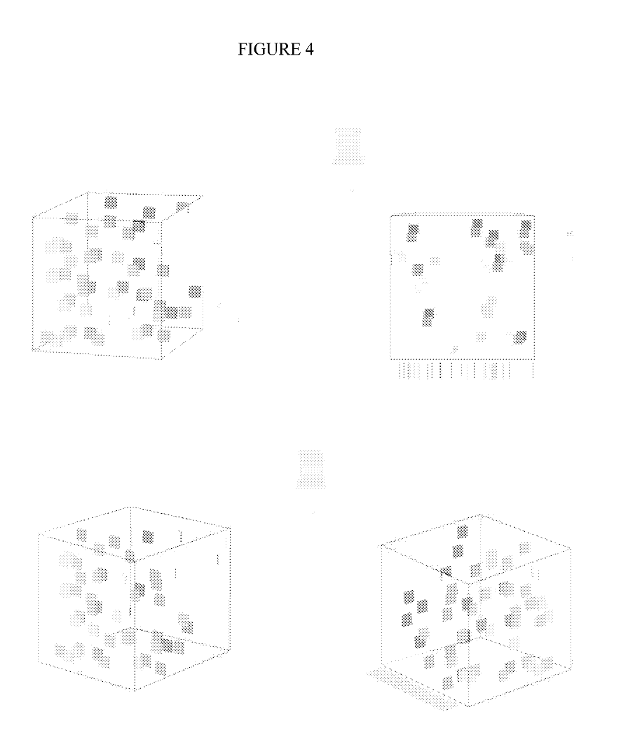

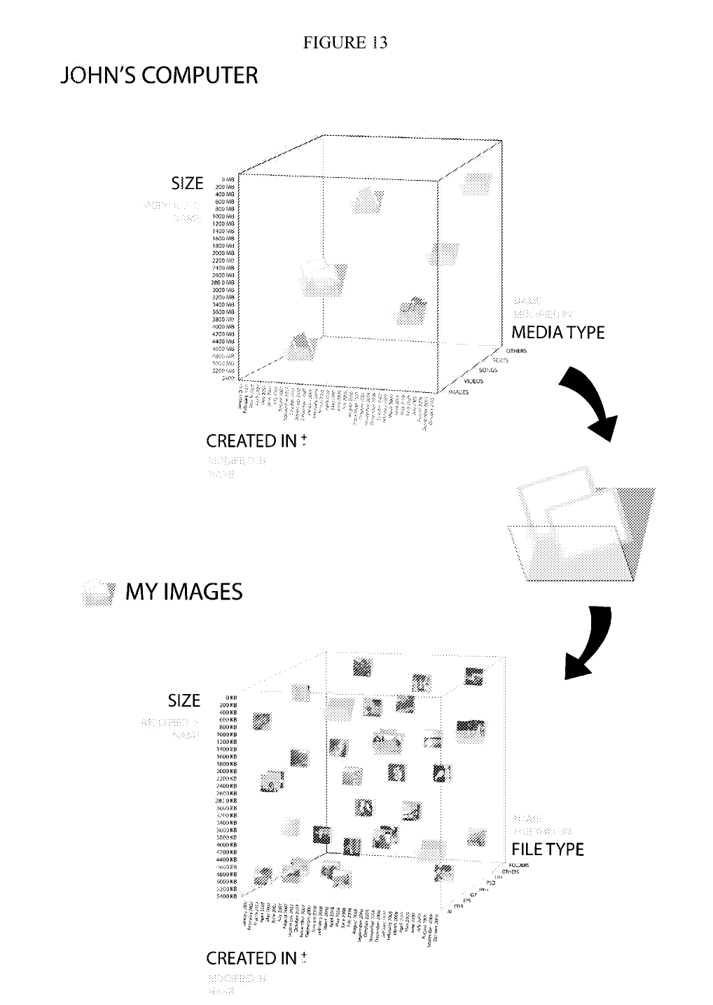

The elements representing multimedia data are illustrated in FIG. 4, wherein said elements are presented by using the same symbol abject regardless of media type. However, depending on the current type, each element has a different edge and a visualization image inside the graphic element. For example, image elements are represented by framed miniature of the images; whereas video elements have a roil film style with a short video sequence inside. In the examples shown in FIG. 4, for multimedia data, it was used the same symbol of objects as a representation of any element of multimedia design. However, the symbol of final objects for the music and images can be seen in the M-cube prototype, shown in FIG. 13.

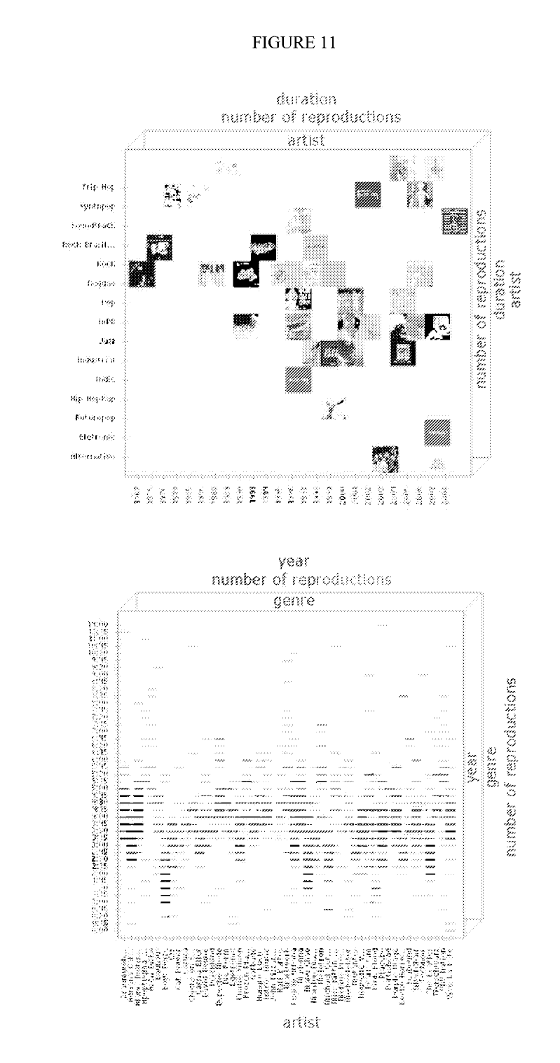

In the case of a music database, the visualization may vary according to the choice of the element to be shown (music track or full album). In FIG. 11, it can be seen an M-Cube prototype made for a collection of musics in two forms on visualization: albuns, on the left, and tracks on the right. In the case of an audio database, it is possible to add an audio representation to symbols, besides the characteristics of existing color and form. A piece of audio is played when the user interacts with a specific element, and stops playing when the user leaves the element. This interaction is different from the opening action, wherein the user wants to touch or look at the entire contents of a media data. While the visualization act or previous reproduction is done by touching the element once, the opening action (selection) is done by means of the double touch.

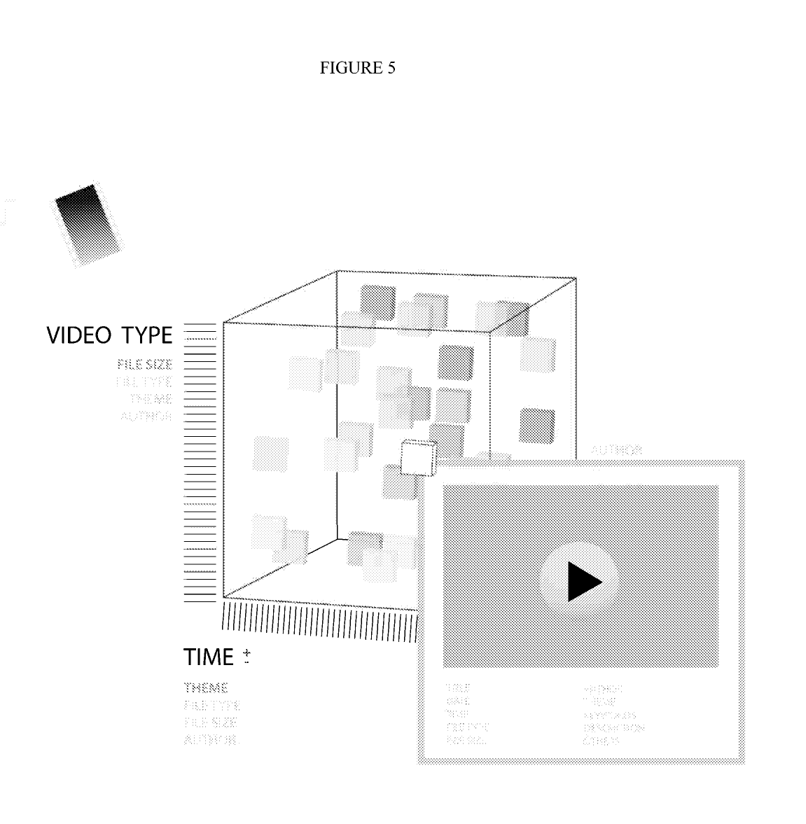

FIG. 5 illustrates an example of the opening action of an element representing video data by using the M-Cube. It is possible to see the action in which the user navigates through the database of videos, changing the dimensions and making filters, up to a specific video is found (highlighted white box in the middle of the cube). The user chooses to open the video that is centered in the white box, by means of the double touch, when the video starts playing.

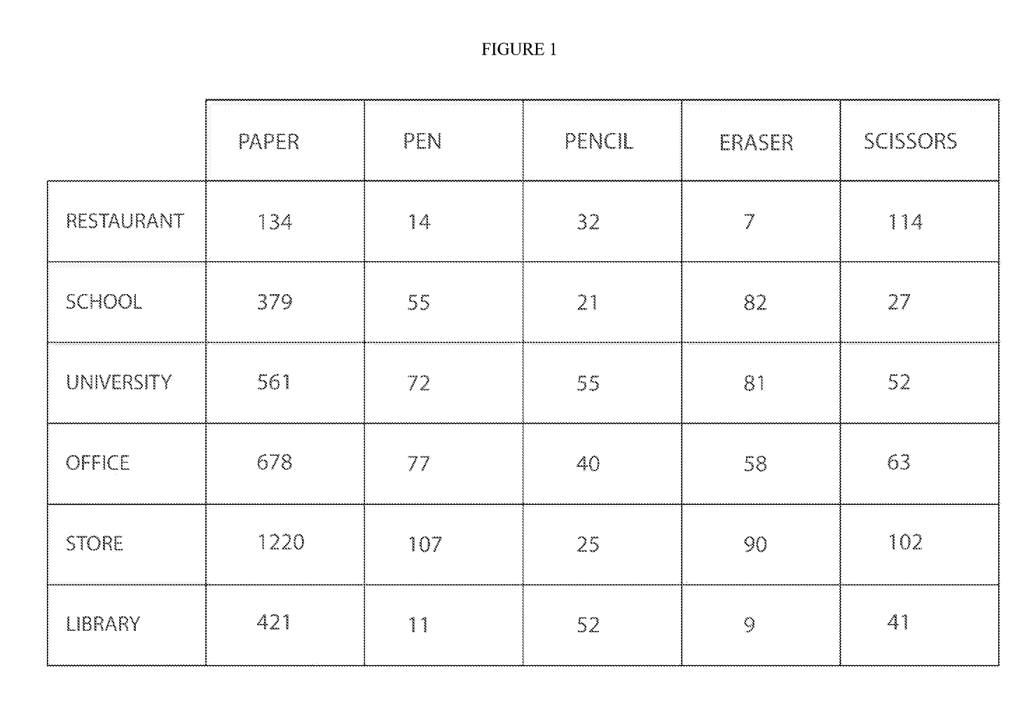

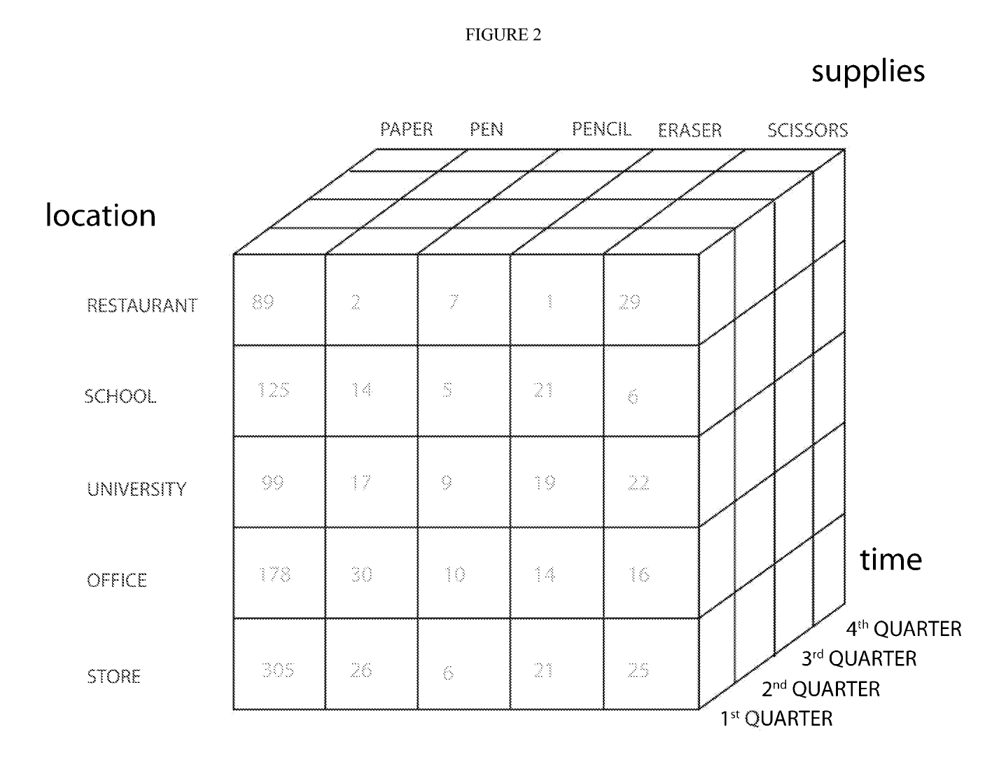

Opening and visualization of elements are important actions when dealing with a rich and complex database, such as a multimedia database. FIGS. 1 and 2, for example, illustrate examples in which the user only wishes to view and analyze only the data (referred to static values or quantities), without wishing to interact therewith.

At the M-Cube interface, the attributes are represented in three axes and the data elements are floating objects that appear inside the cube. The attributes, or dimensions, in each axis have different types of values. For example, the attribute “artist” has as values “name”, whereas the attribute “creation date” is identified by “dates”. Attributes can also have different scales of values. For example, the “creation date” of a data can be expressed in “days”, “weeks”, “months”, etc.

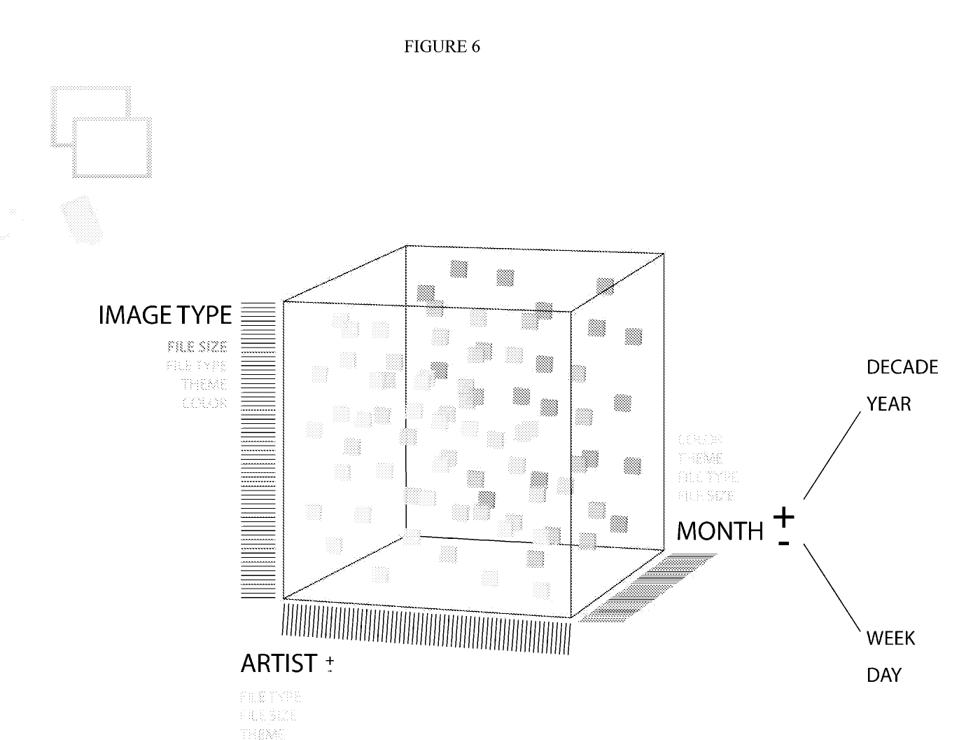

Therefore, the M-Cub interface allows, in addition, the user to choose the scale of any dimension which presents more than one scale. FIG. 6 illustrates an M-Cube for images wherein the user can choose between a more refined or coarser visualization on one of the axes. The option appears in the form of a positive and negative sign when the user touches the current dimension.

Features of the M-Cube

(i) Natural Rotation

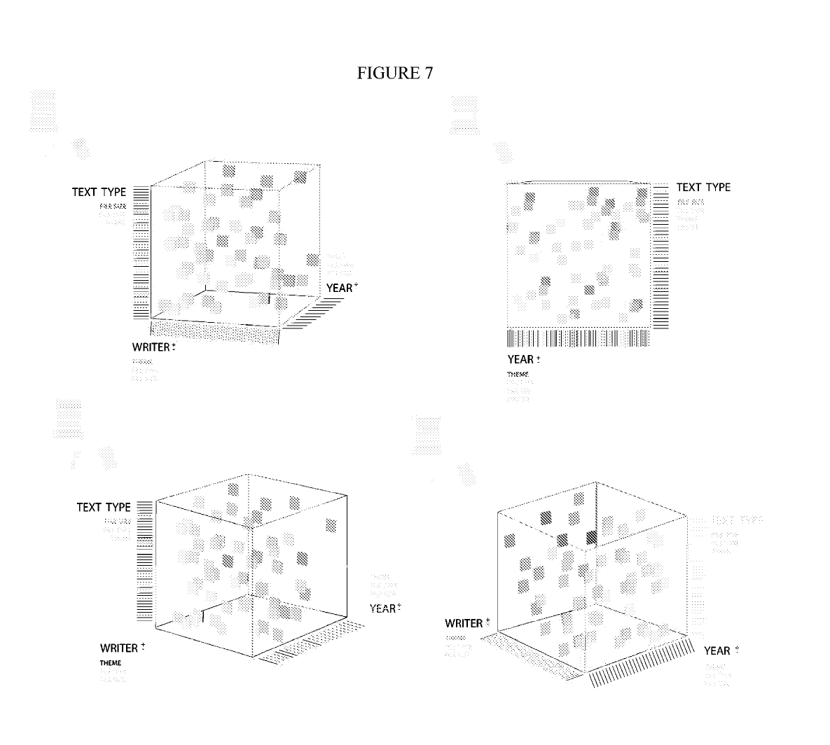

The M-Cube has, as one of its main features, the capability of naturally running the space, in order to facilitate the visualization of data elements. An example of this feature, using text media, can be seen in FIG. 7. In said example the user can manipulate the cube in any direction, making it possible to visualize the data in the preferred faces or turning the cube in a 2D dispersion graphic, aligning the face of the cube to be visualized, as can be seen in the top right corner of FIG. 7. Rotation, in turn, is made by means of touching any part of the cube space and choosing the desired direction to rotate. Such action may be observed in the two inferior cubes of FIG. 7, in which the user rotates the hub in more than one angle, making one of the faces to be more emphasized, thereby changing the axes to adapt to said new configuration.

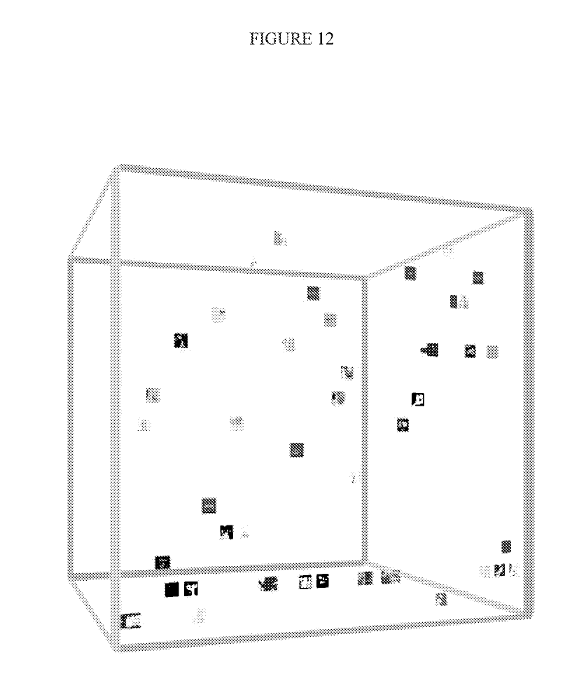

By using the same rotation gesture, the user can alter the dimensions. The M-Cube interface enables the user to touch one of the side dimensions, such as “color” and “theme”, as shown in FIG. 6, in a preferred axis and rotating the cube while touching the side dimension, the current dimensions are changed. In FIG. 12, the M-Cube prototype is shown during the rotation to modify one of its dimensions. This interaction makes easier the exploration of any database, including multimedia files.

ii) Selection of attributes

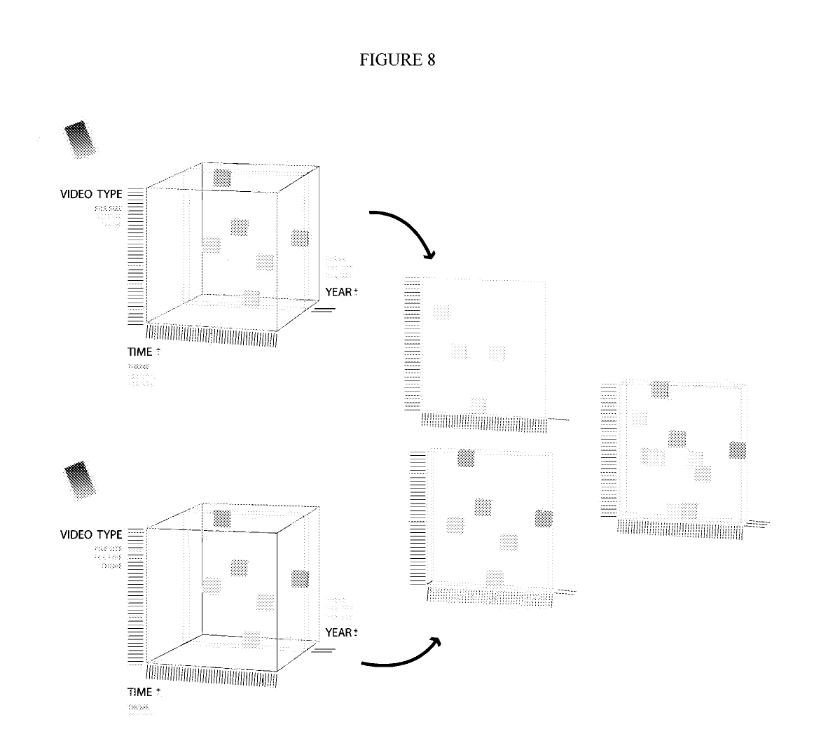

Another important feature of the present invention is the selection of attribute by choosing one or more axes to reduce the visualization of data. The values on the axes may be selected by intervals or by unique values. For example, FIG. 8 shows two selections: in the first selection, the value is chosen in the dimension “year” (top) and then an interval is chosen in the same dimension (bottom). Each time a selection is made, a slice of the M-cube is created with the corresponding selection elements (see the two slices of the cube shown in the middle of FIG. 8). The slices are, then, combined to form a consultation for selection, as shown on the right side of FIG. 8.

The action of selection is used to locate a particular data element or to make subsets of the database. Initially, the selection is aimed to improve the action of the rotation by reducing the number of data elements in the visualization, and, at the end, the selection can be used to make, for example, lists of musics in folders and/or files, whether the user is working with a set of music data.

(iii) Filtering

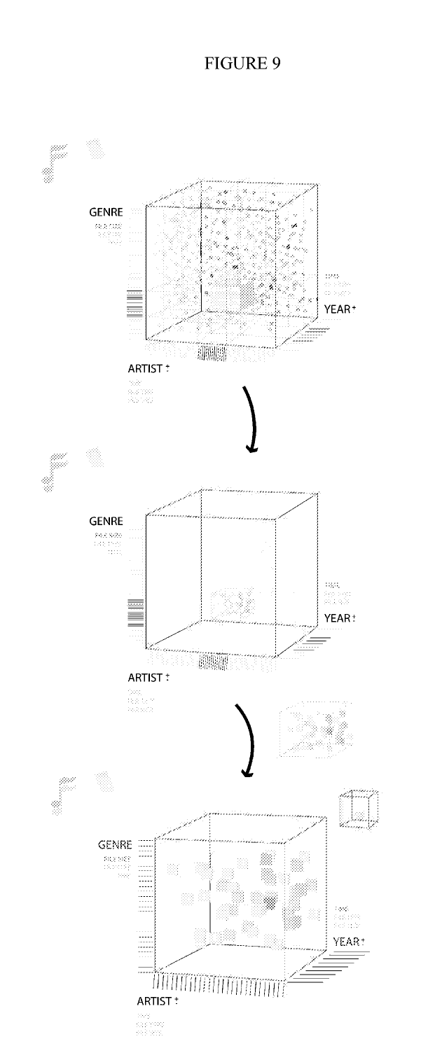

The action of filtering allows the user to select multiple axes at the same time and filter through the M-Cube to visualize the selected axes. FIG. 9, for example, shows a large music data set that is being filtered by an user selection. In a large database, data elements are very small and difficult to visualize. Hence, it is important that both actions of filtering and of selection can be used to improve visualization and/or to build a subset of said data set.

In the example shown in FIG. 9, the user selects the desired values in the following dimensions (top): “genre, artist and year”. The intervals can be selected at the same time, using the two fingers to touch the initial and final values, and the two hands to choose more than one attribute. After selection, it can be seen, through the animation of the M-Cube, the selection from the data original elements up to the elements of the data already filtered (arrows indicate the animation). The result is a new M-cube with dimensions limited by intervals specified by the user (bottom). The original M-Cube appears as an icon in the top right corner of the interface, allowing the user to touch it to return to the original visualization (small cube in the top right corner).

(iv) Expansion (or Zoom)

Another way to better visualize the database is the interaction by the zoom. Large data sets require a large number of graphic elements inside the M-Cube, making difficult to distinguish the elements. Thus, to facilitate the visualization of the data chosen, the user can touch, using two fingers inside the cube to determine a region of enlarging or reducing, controlling the action of expanding the interface. Note that this gesture is different from that in which the user uses the two fingers to touch one of the main axes, in order to make a filtering of attributes.

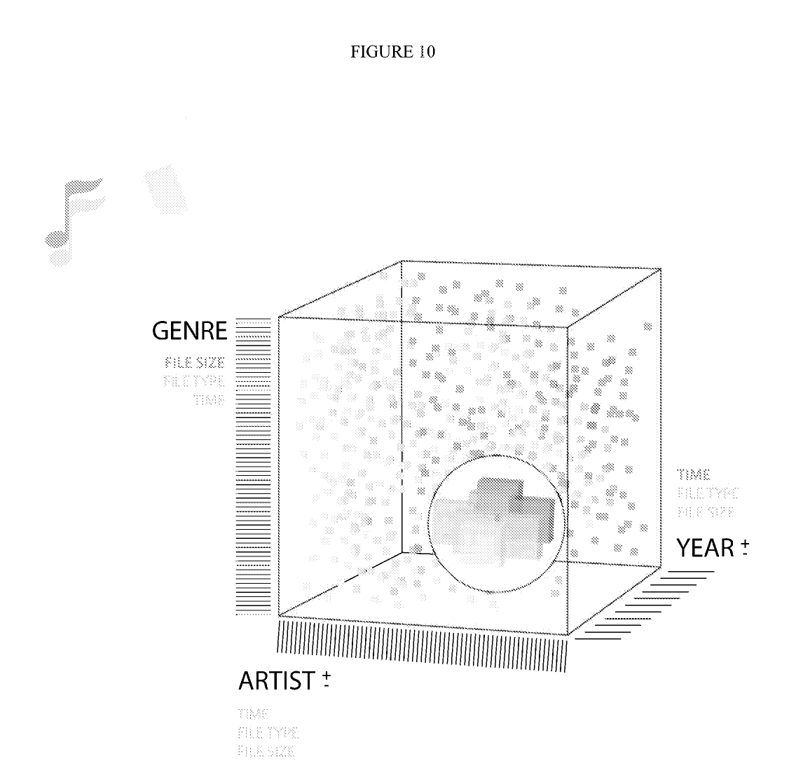

FIG. 10, for example, illustrates the use of the zoom in a large set of music data. The circle with the largest data elements inside is a hand lens; the user defines the amplitude of the lens by moving away or approximating the two fingers. The zoom region can be altered by moving the fingers and changing the position of the lens accordingly. Said interaction is similar to a cartographer which uses a powerful magnifying glass to make the analysis of a map.

In the case of a very large database, such type of zoom may further result in a large group of data elements inside the lens. To solve this problem, the zoom feature allows, then, a second gesture, where the user usually defines the amplitude of the lens and then either (a) separates the fingers to reduce the visualization of data, or (b) joins the fingers to enlarge the zoom.

Those skilled in the art, therefore, will immediately valorize the important benefits which arise from the use of the present invention. Variations in the form of realizing the inventive concept exemplified herein should be understood as within the spirit of the invention and of the attached claims.

1. A method for organizing data from multimedia and/or multimedia databases, comprising presenting said data as a visualization tool in 3D space, which allows at least the following four interactions: rotation, filtering, selection, and expansion.

2. The method according to claim 9, wherein the four interactions in the M-Cube occur as follows:
Rotation—the cube can be rotated for better data visualization or for altering the current dimensions;
Filtering—choice of parts of the edges of the cube for filtering the result for producing a new visualization and for altering consultations in the exploration process;
Selection—individual or joint choice of graphic elements inside the cube to interact with other data; and
Expansion—zoom of regions inside for an adequate view of data, allowing for a quick change of a generic analysis to a more specific one.

3. (canceled)

4. The method according to claim 9, wherein the data in the M-Cube are displayed as 3D graphic elements as objects with different shapes and colors, of which visual aspects of the graphic elements are intended to add more dimensions thereto.

5. The method according to claim 9, wherein the action of selection in the M-Cube is done by clicking with a mouse or by using a touch interface.

6. The method according to claim 2, wherein the expansion comprises (a) separating the fingers to move the visualization area away, or (b) joining the fingers to approximate the visualization area.

7. The method according to claim 2, wherein the filtering comprises touching with one or two fingers on a certain axis, thereby determining a specific attribute value or an interval of values between the fingers.

8. A method according to claim 9, wherein the rotation or the expansion in the M-Cube occurs with the space, instead of directly with the elements where the data are presented.

9. The method according to claim 1, wherein the visualization tool is represented by a Multidimensional Cube (M-Cube), in which data are described by edges of said cube.

10. A multidimensional cube, comprising data described by edges of said cube, wherein said cube is presented as a visualization tool in 3D space, and said cube allows at least the following four interactions: rotation, filtering, selection, and expansion.

11. The multidimensional cube according to claim 10, wherein the cube comprises a multidimensional database visualization tool which employs a 3D space.

12. The multidimensional cube, according to claim 11, wherein the cube enables both (i) a natural rotation of the space, for a better visualization of data objects, and (ii) on the same rotation interface, the change of the three dimensions which are used to project data.

13. The multidimensional cube according to claim 10, wherein the data comprises multimedia data or multimedia databases.
